(19) United States
(12) Patent Application Publication
(10) Pub. No.: US 2012/0205056 A1
(43) Pub. Date: Aug. 16, 2012

(54) SHADING DEVICE AND METHOD FOR INSTALLING THE CASING OF SAID SHADING DEVICE

(75) Inventor: Francisco Guillen Chico, Sax (ES)

(73) Assignee: GAVIOTA SIMBAC, S.L., Sax (ES)

(21) Appl. No.: 13/393,959

(22) PCT Filed: Sep. 3, 2009
(86) PCT No.: PCT/ES09/70367

§ 371 Date: May 3, 2012

(51) Int. Cl. E06B 9/42; B23P 17/04

(52) U.S. Cl. 160/266; 29/428

(57) ABSTRACT

The present invention relates to a shading device which runs along guide rails, allowing said device to be installed and removed easily regardless of the area in which said device is arranged. The shading device prevents wear of the canvas due to the arrangement thereof relative to the guide rails along which said canvas slides. Likewise, the shading device allows the canvas-winding casing to be placed in an intermediate position relative to the guide rails, enabling the configuration of shading devices in which some rails are longer than others.

### OBJECT OF THE INVENTION

The present invention relates to a shading device which runs along guide rails allowing said device to be installed and removed easily regardless of the area in which said device is arranged.

The shading device prevents wear of the canvas due to the arrangement thereof relative to the guide rails along which said canvas slides.

Likewise, the shading device allows the canvas-winding casing to be placed in an intermediate position relative to the guide rails, enabling the configuration of shading devices in which some rails are longer than others.

### BACKGROUND OF THE INVENTION

Shading devices by means of a canvas which can be wound on a shaft and opened by extending a load bar attached to the canvas are known in the state of the art, the canvas shaft being at least partly enveloped by a casing and the load bar being guided by means of several parallel extension guide rails, the mutual distance of which can be adjusted.

The patent with publication number DE102004032725A1 is among the above devices, which patent relates to a shading device in which the casing has a guide profile extending in the longitudinal direction thereof and in which in each guide rail there is arranged an attachment part which is engaged in the guide profile, being able to slide.

In the previous device, the casing is located behind the guide rails to cover the gap located between the guide rails and the wall against which the shading device is normally installed and thus prevent sunlight from entering the area in which the canvas is not arranged.

During the installation of the previous device, the guide rails are attached to the casing by means of a securing element which the attachment part has and which is introduced in the guide rail.

Thus, if it is necessary to remove the casing, for example, to change any element thereof, even the canvas itself, it is necessary to previously remove the guide rails to subsequently remove the casing, or remove the entire device.

This involves a large amount of work, and even more when the guide rails are of great length and are arranged on a glass surface.

Likewise, when the casing of the previous shading device must be assembled forming an angle with the wall against which it is normally assembled or the latter is stepped, the guide rails only reach the casing, there being a gap between the mentioned casing and the wall, therefore it is not possible to fix said guide rails to that wall.

In addition, in the previous device there is the risk of friction between the canvas and the guide rails due to the fact that the position of the casing makes the canvas slide very close to said guide rails, with the consequent deterioration thereof.

All these drawbacks are overcome by means of the invention which is described below.

### DESCRIPTION OF THE INVENTION

The present invention relates to a shading device having a canvas which can be wound and unwound on a shaft and opened by extending a load bar attached to the canvas.

The shaft of the canvas is located inside a casing, whereas the load bar is guided by means of several parallel guide rails, the mutual distance of which can be adjusted and operated by operating means which are not the object of the present invention.

The casing is arranged on top of the guide rails and is fixed thereto by fixing means.

More specifically, the casing is arranged on top of the guide rails such that the vertical projection of the shaft for winding the canvas is projected on the guide rails.

The fixing means comprise grips having a housing to house antagonist flanges of the casing to the guide rails.

Two grips, a front grip and another rear grip, are used to fix the front and rear flanges of the casing. These two grips will be arranged in at least two of the guide rails of the shading device. The housings of the grips are placed in a symmetrical arrangement, such that they face one another to allow the coupling of the flanges of the casing which emerge outwardly therefrom both at the front part thereof and at the rear part.

The housing of at least one of the grips is wedge-shaped to allow carrying out a better retention of the corresponding flange of the casing.

The flanges of the casing are arranged in the base of such casing, which is essentially flat for the correct support of said casing on the guide rails.

To install the casing on the guide rails,
firstly, each rear grip is fixed in a guide rail
the casing is then slid towards the rear grips until the retention occurs between the mentioned rear grips and the casing due to the wedged shape of the housing of the rear grips and of the rear flange of the casing
and finally the front grips are slid towards the casing until they come into contact with the front flange of such casing and the front grips are fixed to the guide rails.

The grips slide on the guide rails with the fixing screws pre-installed therein.

### DESCRIPTION OF THE DRAWINGS

The present specification is complemented with a set of drawings which illustrate the preferred example and never limit the invention.

FIG. 1 shows an elevational view of the shading device in an unfolded arrangement.

FIG. 2 shows an elevational view of one of the guide rails on which the casing is arranged.

FIG. 3 shows a section view of a guide rail on which one of the fixing means for fixing the casing to said guide rail is arranged.

FIG. 4 shows an exploded view of one of the fixing means for fixing the casing to the guide rails together with the nut and screw allowing the attachment thereof to the guide rails.

FIG. 5 shows the arrangement of the casing before it is fixed to the guide rails by the fixing means.

FIG. 6 shows the arrangement of the casing once it has been fixed to the guide rails.

FIG. 7 shows an embodiment when the wall behind the shading device is stepped relative to the guide rails.

FIG. 8 shows an embodiment when the wall behind the shading device is in diagonal relative to the guide rails.

### PREFERRED EMBODIMENT OF THE INVENTION

In view of the above, the present invention relates to a shading device having a canvas (1) which can be wound and unwound on a shaft (2) and opened by extending a load bar (3) attached to the canvas (1).

The shaft (2) for winding the canvas (1) is located inside a casing (4), whereas the load bar (3) is guided by means of two parallel guide rails (5).

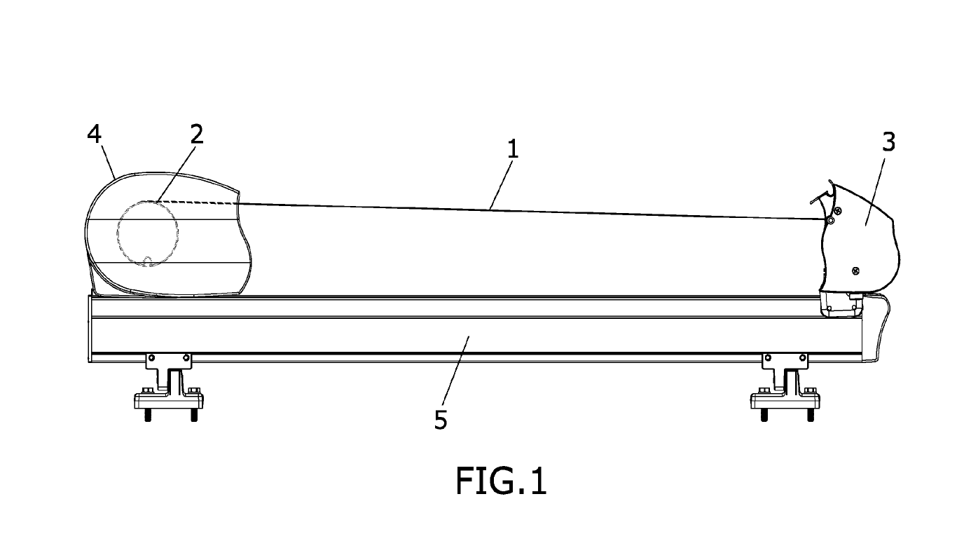

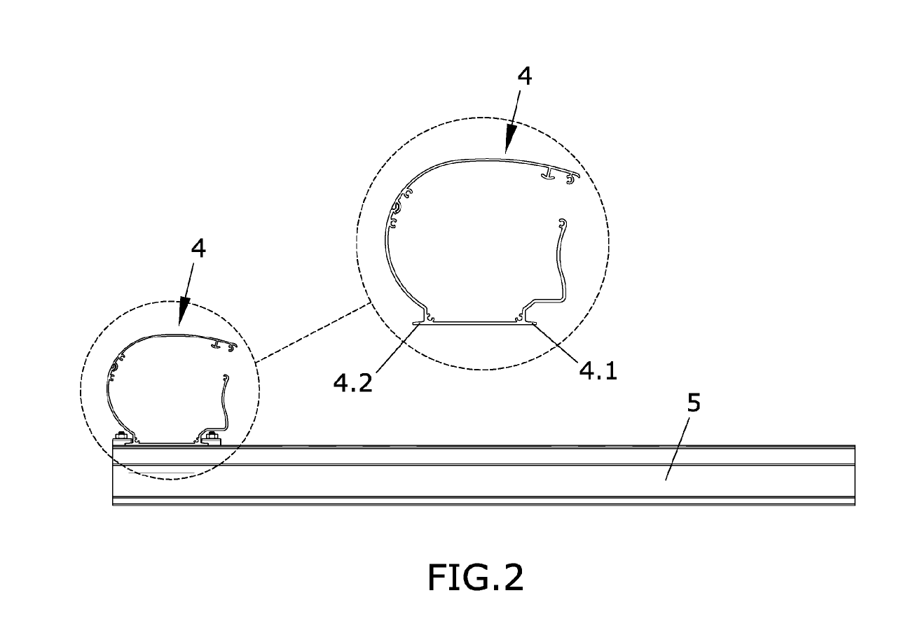

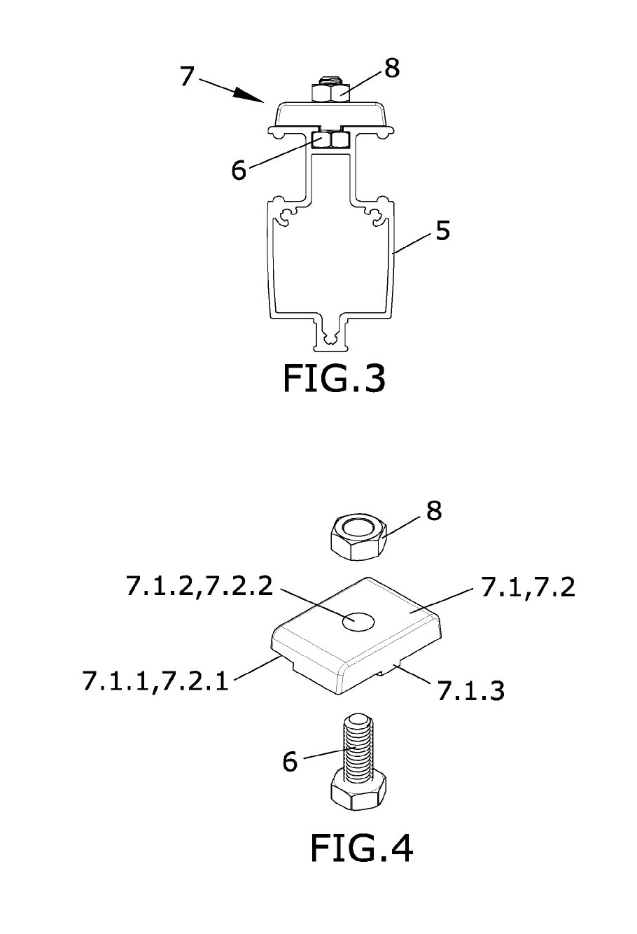

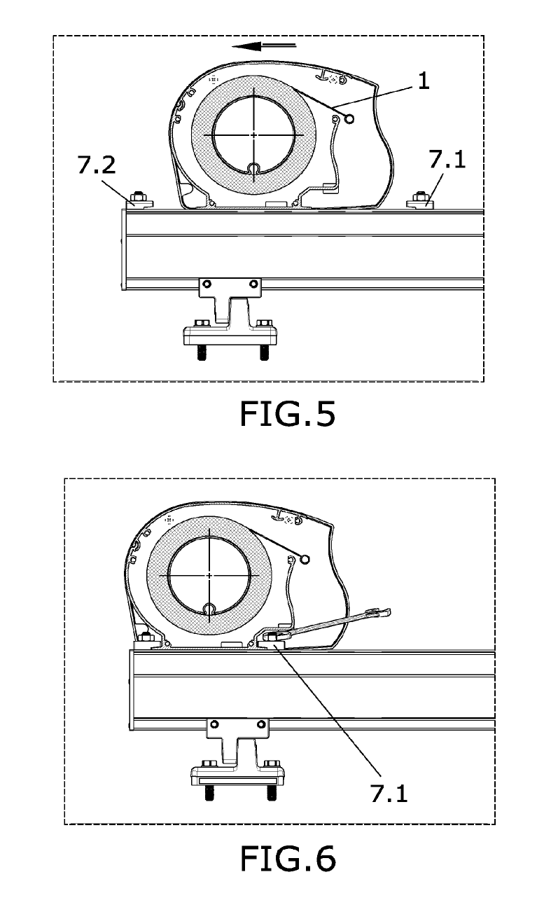

In a first embodiment, these guide rails (5) have a profile with a T-shaped gap in the upper face thereof, as shown in FIG. 1, for housing the head of a screw (6) and subsequently carrying out the fixing to the guide rails (5) of fixing means (7) for fixing the casing (4).

In a second embodiment, not shown in the figures, the guide rails (5) have a cross-shaped profile for leaving a gap for the part of the screw projecting from the nut.

The casing (4) is arranged on top of the guide rails (5) and is fixed to such guide rails (5) by the mentioned fixing means (7) which comprise two grips, a front grip (7.1) and a rear grip (7.2) which have a housing (7.1.1, 7.2.1) to house front (4.1) and rear (4.2) antagonist flanges of the casing (4).

The grips (7.1, 7.2) are fixed to the guide rails (5) by means of the screw (6) housed in said guide rails (5) which traverses a hole (7.1.2, 7.2.2) present in each grip (7.1, 7.2) and is fixed by means of a nut (8).

The front grip (7.1) has a lower projection (7.1.3) fitting in a groove (5.1) present at the upper part of the guide rails (5) to prevent the rotation of said front grip (7.1) when the screw (6) is screwed to the nut (8), this protrusion not being necessary in the rear grip (7.2) to facilitate the sliding of the casing (4) when the rear flange (4.2), also without protrusions, is fitted with the previously fixed rear grip (7.2), since the rear grip (7.2) is usually inaccessible in the presence of the casing (4).

The housings (7.1.1, 7.2.1) of the grips (7.1, 7.2) are placed in a symmetrical arrangement, such that they face one another to allow the coupling of the front (4.1) and rear (4.2) flanges of the casing (4)

The rear grip (7.2) and the rear flange (4.2) are wedged so that a pressure is generated between both and the vertical clearance between both (4.2, 7.2) is thus eliminated.

The flanges (4.1, 4.2) of the casing (4) are arranged in the base of said casing (4), which is flat for the correct support of said casing (4) on the guide rails (5).

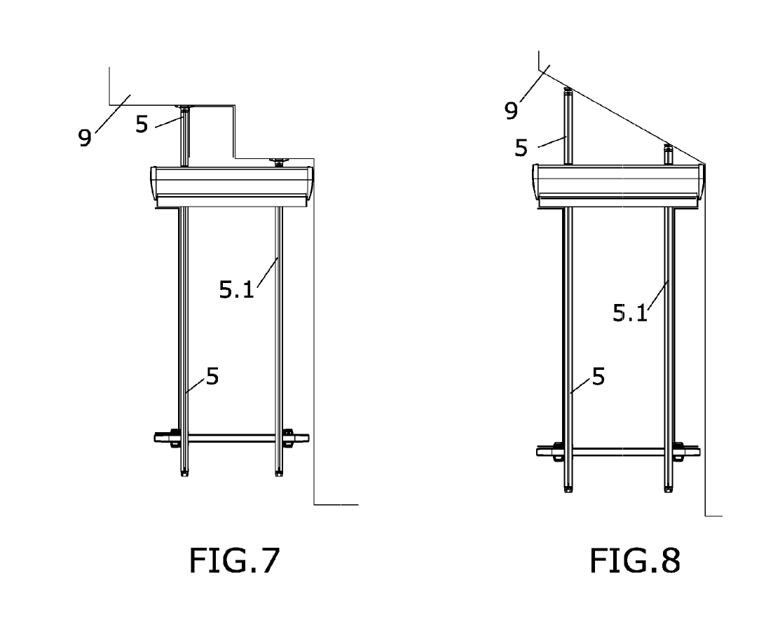

The method for installing the casing on the guide rails, shown in FIGS. 6 and 7, consists of the following steps:
firstly, each rear grip (7.2) is fixed in a guide rail (5)
the casing (4) is then slid towards the rear grips (7.2) until the retention occurs between the mentioned rear grips (7.2) and the casing (4) due to the wedged shape of the housing (7.2.1) of the rear grips (7.2) and of the rear flange (4.2) of the casing (4)
and finally the front grips (7.1) are slid towards the casing (4) until they come into contact with the front flange (4.1) of such casing (4) and the front grips (7.1) are fixed to the guide rails (5).

The grips (7.1, 7.2) slide on the guide rails (5) with the fixing screws (6) pre-installed in such grips (7.1, 7.2).

FIGS. 7 and 8 show embodiments when a wall (9) behind the shading device is stepped or is in diagonal, respectively, relative to the guide rails (5) or the guide rails (5) are required to have a different length.

Variations in materials, shape, size and arrangement of the component elements, described in a non-limiting manner, do not alter the essence of this invention, this being enough for its reproduction by a skilled person.

1. A shading device comprising a canvas (1) which can be wound and unwound on a shaft (2) and opened by extending a load bar (3) attached to the canvas (1), wherein the shaft (2) of the canvas (1) is located inside a casing (4), whereas the load bar (3) is guided by means of several parallel guide rails (5), characterized in that the casing (4) is arranged on top of the guide rails (5).

2. The shading device according to claim 1, characterized in that the vertical projection of the shaft (2) for winding the canvas (1) is projected on the guide rails (5).

3. The shading device according to claim 1 or 2, characterized in that the casing (4) is fixed to the guide rails (5) by fixing means which comprise grips (7.1, 7.2) having a housing (7.1.1, 7.2.1) to house antagonist flanges (4.1, 4.2) of the casing (4)

4. The shading device according to claim 3, characterized in that it has two grips, a front grip (7.1) and another rear grip (7.2), for fixing the front (4.1) and rear (4.2) flanges of the casing (4).

5. The shading device according to claim 4, characterized in that the housings (7.1.1, 7.2.1) of the grips (7.1, 7.2) are placed in a symmetrical arrangement, such that they face one another to allow the coupling of the flanges (4.1, 4.2) of the casing (4) which emerge outwardly therefrom both at the front part thereof and at the rear part.

6. The shading device according to claim 3, 4 or 5, characterized in that the housing (7.2.1) of at least one of the grips (7.2) is wedge-shaped to allow carrying out a better retention of the corresponding flange (4.2) of the casing (4).

7. The shading device according to claim 3, characterized in that the flanges (4.1, 4.2) of the casing (4) are arranged in the base of such casing (4), which is essentially flat.

8. The shading device according to claim 3, characterized in that the guide rails (5) have a profile with a T-shaped gap in the upper face thereof for housing the head of a screw (6) and subsequently carrying out the fixing to the guide rails (5) of the fixing means (7) for fixing the casing (4).

9. The shading device according to claim 8, characterized in that the grips (7.1, 7.2) are fixed to the guide rails (5) by means of the screw (6) housed in said guide rails (5) which traverses a hole (7.1.2, 7.2.2) present in each grip (7.1, 7.2) and is fixed by means of a nut (8).

10. The shading device according to claim 9, characterized in that the front grip (7.1) has a lower projection (7.1.3) fitting in a groove (5.1) present at the upper part of the guide rails (5) to prevent the rotation of said front grip (7.1) when the screw (6) is screwed to the nut (8)

11. The shading device according to claim 4, characterized in that the rear grip (7.2) and the rear flange (4.2) are wedged so that a pressure is generated between both and the vertical clearance between both (4.2, 7.2) is thus eliminated.

12. A method for installing the casing of a shading device on the guide rails on which it is arranged, characterized in that it comprises the following steps:
firstly, rear grips (7.2) are fixed in the guide rails (5),
the casing (4) is then slid towards the rear grips (7.2) until the retention occurs between the mentioned rear grips (7.2) and the casing (4) due to the wedged shape of a housing (7.2.1) of the rear grips (7.2) and the rear flange (4.2) of the casing (4),
and finally front grips (7.1) are slid towards the casing (4) until they come into contact with a front flange (4.1) of such casing (4) and the front grips (7.1) are fixed to the guide rails (5).

13. The method for installing the casing of a shading device on the guide rails on which it is arranged according to claim 12, characterized in that the grips (7.1, 7.2) slide on the guide rails (5) with fixing screws (6) pre-installed in such grips (7.1, 7.2).
